(19) United States
(12) Patent Application Publication
(10) Pub. No.: US 2006/0277456 A1
(43) Pub. Date: Dec. 7, 2006

(54) Method for handling annotations

(75) Inventors: Marina Biberstein, Kiryat Motzkin (IL); Daniel Citron, Haifa (IL); Alberto Giammaria, Austin, TX (US); Bilha Mendelson, Haifa (IL); Vugranam Sreedhar, Yorktown Heights, NY (US)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/146,631

(22) Filed: Jun. 7, 2005

(51) Int. Cl. G06F 17/24

(52) U.S. Cl. 715/512

(57) ABSTRACT

A taxonomy for annotations found in program code. The taxonomy includes a set of meta-annotations associated with an annotation definition and a set of values for each meta-annotation. The meta-annotations describes properties of each annotation. The values describe one quality of its associated meta-annotation. The taxonomy is used in a method for instrumenting a piece of code. The method includes reviewing meta-annotations attached to each annotation definition within the piece of code to determine how to proceed with instrumenting the piece of code.

### FIELD OF THE INVENTION

The present invention relates to program code generally and to annotations therein in particular.

### BACKGROUND OF THE INVENTION

Some types of computer programs are compiled into a platform-independent code, which is executed on a virtual machine. A program that has been compiled into a platform-independent code has the advantage that it can execute on any virtual machine that supports the platform-independent code regardless of what type of underlying central processing unit and native code are used to implement the virtual machine.

A virtual machine typically includes an interpreter, which interprets the platform-independent code into native code to perform the desired operations. Interpreting the platform-independent code is an inherently slow operation. Therefore, many virtual machine implementations also include a dynamic (or just-in-time) compiler, which dynamically compiles the platform-independent code at runtime into the native code for the machine being used to host the virtual machine. Compiling the platform-independent code into the native code for the host machine can reduce the execution time of the program and, therefore, increase throughput.

One of the most popular computing languages is JAVA, which is compiled into a JAVA Virtual Machine (JVM) platform. Many other languages, such as C++, compile to the Common Language Runtime (CLR) of which the .NET system of Microsoft, Inc. of the USA is one implementation.

Sometimes, a programmer may want to communicate information to external tools that may run the program or otherwise interact with it, or to communicate in a generic way between different components of the same program. For example, the programmer may want to indicate something to a development tool, or to pass information from an offline tool to an online tool. One method of doing so may be through “annotations”, information blocks that may be attached to certain program entities (such as classes, fields, or methods). Program annotations may store information from application developers or tools to be provided to the virtual runtime (or other static or run-time tools) so as to specialize or tailor the execution of the application.

In Java and CLR, annotations constitute a powerful mechanism that enables information to be passed between programmers, tools, and the runtime, from the source code level up to the execution time. Program annotations enrich the program semantics and facilitate optimizations. They describe method usage (test markers, web method markers), convey optimization hints (static register allocation schemes, redundant runtime checks markup), or aid in code development and maintenance (author name, tags, bug tracking). Annotations used by the Microsoft NET implementations of the CLR provide hints to serialization, remoting services, interoperation with native code, and more.

FIG. 1, to which reference is now briefly made, is a bit of source code illustrating two exemplary annotations, “@array_null_check” and “@WebMethod”. The present application will use the Java form “@X” for annotations. It will be appreciated that other forms of annotations are known and are incorporated herein.

The annotations may be found at the beginning of the source code. For example, in lines 2 and 3 of a routine named getFullList. The two annotations operate differently. As explained in more detail hereinbelow, the annotation @array_null_check may indicate that a nullity check may not need to be performed for a specific array access due to a previous access to the same array within the annotated method, while the annotation @WebMethod may convert the routine getFullList to a Web service type of method.

In Java, every array access must be accompanied by a reference nullity check and array boundary checks, to ensure that correct exceptions are thrown by the runtime if necessary. An analysis may be performed to determine when such checks are superfluous due to previous array accesses within the method. The results of this analysis are conveyed through annotations attached to the analyzed method. For example, the class file annotation @array_null_check(10) means that checks at line 10 (which is an assignment of “CustomerInfo current=customers[i]”) can be omitted due to at least one previous array access, such as at line 9: “for (int i=customers.length-l; i>=0; i—)”.

Web services are gaining popularity as a way to integrate heterogeneous distributed applications or services. A client and a web service provider communicate using HTML- or SOAP-formatted messages. Web services are published using the Web Service Description Language (WSDL). In both the J2EE and NET programming platforms, methods that implement web services need special support from tools and runtime. In NET, web services are marked as such by the programmer using annotations (known in CLR as custom attributes); attaching the @WebMethod annotation to a public method converts it into a web method.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an exemplary piece of code having two annotations;

FIG. 2B is a first, exemplary instrumentation of the code of FIG. 1;

FIG. 2C is a second, exemplary instrumentation of the code of FIG. 1;

FIG. 3 is an exemplary annotation definition having an annotation taxonomy constructed and operative in accordance with the present invention; and

FIG. 4 is a flow chart illustration of a method for instrumenting code having annotations therein, operative in accordance with a preferred embodiment of the present invention.

It will be appreciated that, where considered appropriate, reference numerals may be repeated among the figures to indicate corresponding or analogous elements.

### SUMMARY OF THE PRESENT INVENTION

Applicants have realized a shortcoming of annotations, that they interfere with instrumentations. Applicants have further realized that the instrumentations need to know some aspects of the annotations in order not to improperly affect them.

There is therefore provided, in accordance with a preferred embodiment of the present invention, a taxonomy for annotations found in program code. The taxonomy includes a set of meta-annotations associated with an annotation definition and a set of values for each meta-annotation. The meta-annotations describe properties of the annotation and each value describes one quality of its associated meta-annotation.

Additionally, in accordance with a preferred embodiment of the present invention, the properties may be attachment level, scope, retention, lifecycle, sensitivity and healing.

There is also provided, in accordance with a preferred embodiment of the present invention, a method for instrumenting a piece of code. The method includes reviewing meta-annotations attached to each annotation definition within the piece of code to determine how to proceed with instrumenting the piece of code.

Moreover, in accordance with a preferred embodiment of the present invention, the reviewing includes considering what the meta-annotations say about when, where, what and how the instrumentation will affect each annotation.

Further, in accordance with a preferred embodiment of the present invention, the method includes removing the annotation if such is indicated by the meta-annotation.

In addition, in accordance with a preferred embodiment of the present invention, the method includes canceling the instrumentation within a scope of the annotation if such is indicated by the meta-annotation.

Additionally, in accordance with a preferred embodiment of the present invention, the method includes moving a portion of the code, as indicated by an attachment level meta-annotation, to another part of the code.

Moreover, in accordance with a preferred embodiment of the present invention, the method also includes repeating the step of reviewing for each annotation and instrumenting the code wherever the meta-annotations have not indicated a problem with their associated annotation.

Finally, there is also provided, in accordance with a preferred embodiment of the present invention, a computer product readable by a machine, tangibly embodying a program of instructions executable by the machine to perform method steps for instrumenting a piece of code. The method steps include reviewing meta-annotations attached to each annotation definition within the piece of code to determine how to proceed with instrumenting the piece of code.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Unless specifically stated otherwise, as apparent from the following discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

Applicants have realized that annotations are not the only thing which may affect the program behavior at runtime. Code may additionally be “instrumented” to measure various aspects of the operation of the code as it is running and, as Applicants have realized, this instrumentation may affect the operation of at least some of the annotations in the code.

Instrumentations are commonly used to track application behavior. For example, they may collect program profiles, monitor component health and performance, aid in component testing, and more. Instrumentation aims to gather additional information about the system rather than modify the structure and/or behavior of the original program. Bytecode instrumentation uses structural and semantic information provided by language and platform specifications both to identify instrumentation points and to avoid affecting the structure and behavior of the original program. Both Java and NET provide profiling APIs for run-time program transformation and instrumentation, although the APIs from NET are non-standard.

Applicants have realized that there may be subtle interactions between annotations and instrumentation. In general, instrumentation tools are not aware of the semantics of information passed via the annotation mechanism. As a result, the interaction between instrumentation and program annotation can cause the application to behave in unexpected ways.

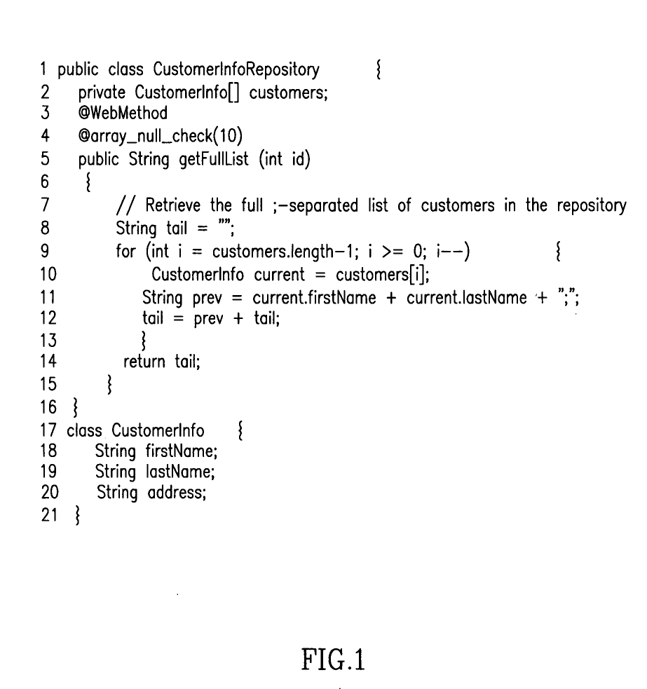

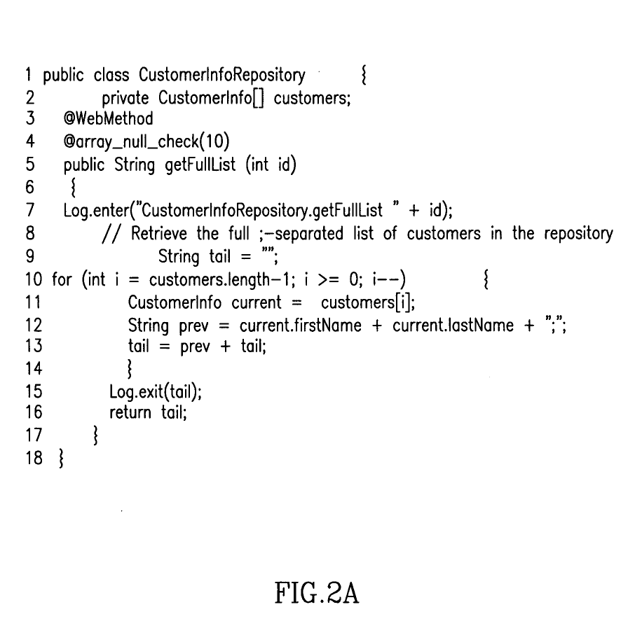

For example, reference is now made to FIGS. 2A and 2B which provide instrumentation to the code of FIG. 1. As discussed in the Background, FIG. 1 provides code for a sample web method having the annotations @WebMethod and @array_null_check.

FIG. 2A illustrates one exemplary instrumentation of the code of FIG. 1. The instrumentation adds some extra instructions (in lines 7 and 15 in FIG. 2A) which have the side effect of moving the original instructions. In the code of FIG. 2A, line 10 is now what was line 9 in the code of FIG. 1, e.g. “for (int i=customers.length-l; i>=0; i—)”. This is a first access of the referenced array within the annotated method and thus, the nullity check for it is necessary and the @array_null_check annotation is now wrong. In annotations referencing bytecode offsets rather than line numbers, there may not be any instruction starting at the specified offset after the instructions are shifted by instrumentation. No matter what happens, the annotation users may have no indication that the annotation has been made invalid. If they continue to use it in the presence of instrumentation, the result may be a program with security hazards and unexpected behavior.

In another example, shown in FIG. 2B, the code of FIG. 1 was instrumented to create a method-level profile of the application. To do so, the instrumentation may have moved the profiled method's body into a new method (called “getFullList( )”) and then added some instrumentation instructions into the body of the method getFullList( ). The method getFullListI( ) is now an exact copy of what getFullList( ) was before the instrumentation, so the instrumentation has moved the two annotations @array_null_check and @WebMethod into getFullListI( ).

Unfortunately, the result is that the original getFullList( ) is no longer a web method, since it does not include the annotation @WebMethod. The method getFullListl( ), on the other hand, is a web method, but it is not publicly available since it is defined as a private routine (see its line 3).

Applicants have realized that providing a communication mechanism between annotations and instrumentations may prevent the instrumentation from accidentally corrupting any existing annotations. Moreover, such a communication mechanism may help other units and/or developers which operate on the code.

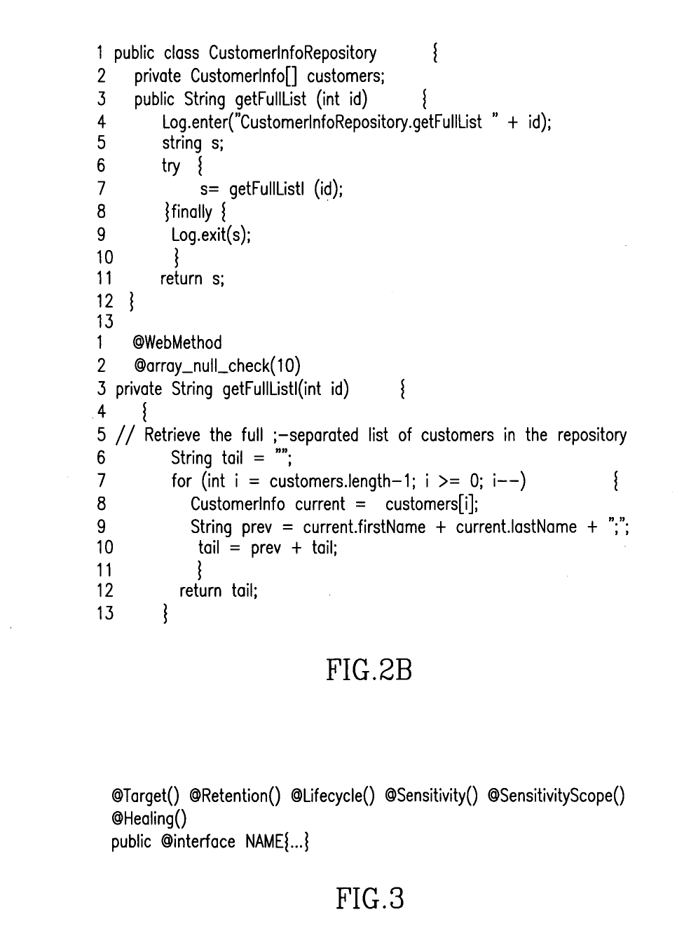

Reference is now made to FIG. 3, which is an exemplary definition for an annotation whose name is NAME, using an annotation taxonomy constructed and operative in accordance with the present invention. In the definition of FIG. 3, the annotation begins with the line stating “public @interface NAME{ . . . .}”. In accordance with a preferred embodiment of the present invention, prior to the opening line, some properties of the annotation are listed, as “meta-annotations”, using a syntax found in JAVA. In FIG. 3, six properties are listed, @Target( ), @Retention( ), @Lifecycle( ), @Sensitivity( ), @SensitivityScope( ) and @Healing( ). Other properties defining the relationship of the annotation to changes in the code around it may also be provided and are included in the present invention.

The taxonomy of FIG. 3 may indicate to instrumentation how to handle any annotations which it may find. It may also be useful for communicating to other elements involved in the programming process, such as developers, compilers, environments, etc., information regarding the annotation and how sensitive it is to changes in the code with which it is associated.

The meta-annotations of the present invention may attempt to answer the following questions:
a) When?—What changes does the instrumentation apply and what changes is the annotation sensitive to?
b) Where?—Where does the instrumentation apply its changes and where may they affect the annotation?
c) What?—Is the annotation relevant during the stage of program development and execution when the instrumentation is run?
d) How?—How should the annotation be treated if it is (potentially) affected?

@Target

The Target meta-annotation is a standard meta-annotation in JAVA and has the values defined by the java.lang.annotation.ElementType enumeration, such as TYPE, FIELD, and METHOD. It is used in the present invention to indicate the type of program element(s) on which the annotation operates. This enables an annotation to be specific to a program element, such as a class, a field, or a method. The present invention may include further values, such as BYTECODE_INSTRUCTION and METHOD_CODE, to provide generally more specific attachment levels for the program element. The present invention may also include the means of attaching annotations to entities such as code lines, bytecode instructions or the bodies of a method.

For example, as discussed hereinabove, the annotation @array_null_check describes an individual line instruction and may be attached to instructions whenever an analysis establishes that the usual reference nullity checks can safely be omitted for these instructions. In accordance with a preferred embodiment of the present invention, if the value of @Target is INSTRUCTION, the platform which may compile the annotation may preserve the annotation attached to a specific instruction, for example, by checking a field of the annotation which may specify the line (or bytecode offset) to which it is attached. The instrumentation may, upon reading the instruction-attached annotation, fix the instruction offset within the code to maintain the location of the bytecode instruction and thus, the annotation may be retained in spite of the instrumentation.

Another example may be an annotation providing an intra-procedural register allocation scheme. Such an annotation may be extremely volatile. If the annotation is marked as method-attached (i.e. if the value of @Target is METHOD), then the instrumentation may either leave the method alone or remove the annotation. However, if the @Target meta-annotation has a value of METHOD_CODE, indicating that the annotation is attached to the method body rather than the method as a whole (e.g. the body together with the declaration), then the instrumentation may move the method body (together with the annotation attached to it) to a new method. The latter may provide instrumentation while retaining the optimizing annotation.

@Retention

The @Retention meta-annotation is another standard meta-annotation in Java (with possible values of SOURCE, CLASS and RLNTIME) and indicates whether a particular annotation should be preserved in the source, class file, or at runtime respectively. The present invention may utilize the @Retention meta-annotation.

@Lifecycle

The @Lifestyle meta-annotation may attempt to provide a more detailed picture of annotation usage. An additional benefit is that such a markup may help ensure that any sensitive annotation be removed from the binary codes before shipping. For example, the lifecycle of @WebMethod and @array_null_check may be DEPLOYMENT (i.e. they are active during running of the code). The lifecycle of @ExpectedException, used by a testing suite to mark the test outcome, may be INTEGRATION (i.e. it is active during the integration process).

Table 1 shows an example set of values that the meta-annotation @Lifecycle may take on:

TABLE 1
Annotation Lifecycle

| Name | Description |
|---|---|
| DEVELOPMENT | Annotations are last used during component |
| | development and testing |
| INTEGRATION | Annotations are last used during the development |
| | and testing of components that use the annotated |
| | component |
| DEPLOYMENT | Annotations are last used at the component |
| | production stage (default) |

@Scope

The scope of an annotation may be the set of classes and class elements whose modification may affect the correctness of an annotation. For example, an annotation may be “package-scoped” if changes only to the classes within the package may render it incorrect. Some annotations may have scopes that are quite difficult to describe. For example, a security annotation claiming that a method only accesses files within a certain directory actually covers not only the method itself, but also its direct and indirect callees. The possible exception may be those callees that exclude themselves from the checks (e.g., using Java's PriviledgedAction mechanism). Such scopes may be described conservatively.

Further complexities in Java exist due to its flexible class loading. While at the Java source code level, it makes sense to talk about application- or package-wide scope, in bytecode, such annotations may only be supported using a special-purpose annotation type to combine the restrictions of the combined annotations at the package or application levels. The special-purpose annotation type should be placed by the compiler as a package level bytecode annotation for package-scoped sensitivity or at every application entry point for application-level sensitivity.

Table 2 shows an exemplary set of values that the meta-annotation @Scope may take on:

TABLE 2
Annotation Scope

| Name | Description |
|---|---|
| CURRENT | Annotations sensitive only to changes to the program |
| | element (e.g. class, method, parameter) to which they |
| | are attached |
| MEMBER | Annotations sensitive only to changes to the class |
| | members to which they are attached or to whose sub- |
| | elements they are attached |
| CLASS | Annotations sensitive only to changes to the classes to |
| | which they are attached or to whose sub-elements they |
| | are attached |
| HIERARCHY | Annotations sensitive only to changes to the classes to |
| | which they are attached or to whose sub-elements they |
| | are attached, and to their sub-types |
| PACKAGE | Annotations sensitive only to changes to the classes to |
| | which or to whose sub-elements they are attached, and |
| | other classes in the same package (default) |
| PROGRAM | Annotations sensitive to changes anywhere within the |
| | program |

@Sensitivity

Given a scope, annotation sensitivity may describe which changes within the annotation scope may render the annotation incorrect. For example, the annotation @WebMethod is not sensitive to instrumentation changes within the program; however, @array_null_check may be sensitive to any change within the body of the annotated method, because instrumentation moves instructions to different offsets. An annotation may be described using one or more (scope, sensitivity) pairs.

The only way to conservatively describe the annotation sensitivity may be to declare it sensitive to any change. This may be the default option. However, Table 3 lists “non_spectative_change” as another level of sensitivity as well. “Spectative change” is a change, usually made by instrumentation, which may preserve the program structure and functionality, allowing only minor side effects such as increases in execution time or changes to the log file.

TABLE 3
Annotation Lifecycle

| Name | Description |
|---|---|
| ANY_CHANGE | Annotations sensitive to all changes |
| | within the scope (default) |
| NON_SPECTATIVE_CHANGE | Annotations not sensitive to spec- |
| | tative changes within the scope |

It will be appreciated that the meta-annotations @Scope and @Sensitivity may operate together. The @Sensitivity meta-annotation may define the sensitivity within the scope described by the @Scope meta-annotation.

@Healing

Rendering an annotation invalid should not necessarily prevent instrumentation. Indeed, most of the annotations suggested in the literature, such as @array_null_check, have an advisory character. The healing meta-annotation serves to mark an annotation whose absence can be fixed by tools downstream in the production process. One such characteristic may be if the annotation is optional or mandatory.

For other annotations, it may be cheaper to check them than to re-generate them. One such annotation is @StackMap, which maps the types of variables in a method to the stack frame entries of the method. @StackMap generally may take a long time to generate and thus, it may be more useful to maintain it even if it is violated. The proposed healing options are enumerated in Table 4. For example, the healing for @WebMethod may be CANCEL, while for @array_null_check, it may be REMOVE.

TABLE 4
Annotation Healing

| Name | Description |
|---|---|
| CANCEL | Annotations must be preserved, so changes must be |
| | canceled (default) |
| IGNORE | Annotations may be retained even if invalid |
| IGNORE_CATCH | Annotations may be retained even if invalid, but |
| | this may result in unexpected exceptions in the |
| | modified code |
| REMOVE | Annotations must be removed |

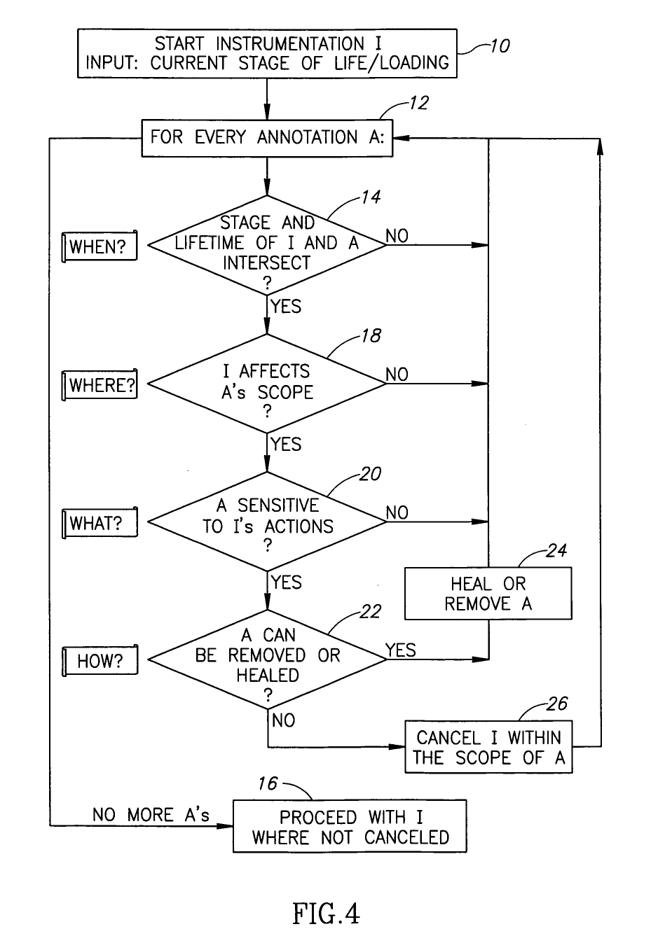

Reference is now made to FIG. 4, which illustrates a method which an instrumentation may follow when encountering annotations which are labeled with the meta-annotation taxonomy discussed hereinabove.

At step 10, the instrumentation program may receive an instruction to begin the instrumentation I and may receive, as input, an indication of the current stage in the lifecycle of the program being instrumented.

When the instrumentation program encounters (step 12) an annotation A, it may first attempt to answer the “When” question and may check (step 14) to see where in the lifecycle annotation A is active. If the @Lifecycle meta-annotation denotes a stage earlier than the one that the instrumentation program received as input (i.e. if the program being instrumented is at a stage where annotation A is no longer used), or if the annotation retention is such that the annotation is no longer available for the later stages (e.g., if the meta-annotation @Retention value is CLASS and the instrumentation is done at class loading), then the instrumentation will not affect the annotation and the instrumentation program may return to step 12 to check the next annotation A′.

However, if the instrumentation occurs at or before the lifecycle indication in @Lifecycle, then the instrumentation may affect the annotation and thus, the instrumentation program may proceed to the “Where” question for the current annotation. In step 18, the instrumentation program may check the @Scope meta-annotation to see if instrumentation may affect the scope of annotation A. If it doesn't affect the scope, then the instrumentation program may return to step 12 to check next annotation A′.

It is noted that the instrumentation program may check both the @Scope and the @Target meta-annotations to determine the scope of annotation A. The more precise the values for @Target, the more limited the scopes may be. Thus, if the value of the @Scope meta-annotation is ‘CURRENT’, then the scope may depend on the @Target granularity and/or on the @Retention meta-annotation. For example, if @Target has a value of INSTRUCTION, then the instrumentation may insert new code into the annotated method (subject to the usual instrumentation restrictions of maintaining the program semantics and structure), without affecting the annotation scope. Note, however, that such an instrumentation would be required to maintain the correct instruction offsets in instruction-attached annotations, the same as for bytecode instructions that contain such offsets.

If the instrumentation does affect the scope of the annotation, then the instrumentation program may proceed to the “What” question. In step 20, the instrumentation program may check the @Sensitivity meta-annotation to see if annotation A is sensitive to the actions of the instrumentation program. If it is not sensitive, then the instrumentation program may return to step 12 to check next annotation A′.

If it is sensitive, then the instrumentation program may proceed to the “How” question. In step 22, the instrumentation program may check the @Healing meta-annotation to see how to heal, or if to remove, annotation A.

If annotation A may be healed or removed, the instrumentation program may proceed to step 24 and may perform the change indicated by the @healing meta-annotation. The instrumentation program may then return to step 12 to check next annotation A′.

If no healing may be performed, then the instrumentation program may cancel (step 26) the addition of instrumentation within the scope of annotation A and may so note the cancellation of instrumentation within that scope. As long as the scope of annotation A is not the entire program, the instrumentation program may then proceed to check next annotation A′.

Once all annotations have been checked, the instrumentation program may proceed to step 16 and may add instrumentation wherever it has received permission to do so (i.e. in the scopes remaining from step 26).

While certain features of the invention have been illustrated and described herein, many modifications, substitutions, changes, and equivalents will now occur to those of ordinary skill in the art. It is, therefore to be understood that the appended claims are intended to cover all such modifications and changes as fall within the true spirit of the invention.

What is claimed is:

1. A taxonomy for annotations found in program code, the taxonomy comprising:
a set of meta-annotations associated with an annotation definition, said meta-annotations describing properties of said annotation; and
a set of values for each said meta-annotation, each said value describing one quality of its associated meta-annotation.

2. The taxonomy of claim 1 and wherein said properties comprise at least one of the following properties: attachment level, scope, retention, lifecycle, sensitivity and healing.

3. A method for instrumenting a piece of code, the method comprising:
reviewing meta-annotations attached to each annotation definition within said piece of code to determine how to proceed with instrumenting said piece of code.

4. The method of claim 3 and wherein said reviewing comprises considering what the meta-annotations say about when, where, what and how the instrumentation will affect each annotation.

5. The method of claim 4 and also comprising removing said annotation if such is indicated by said meta-annotation.

6. The method of claim 4 and also comprising canceling the instrumentation within a scope of said annotation if such is indicated by said meta-annotation.

7. The method of claim 4 and also comprising moving a portion of said code, as indicated by an attachment level meta-annotation, to another part of said code.

8. The method of claim 4 and also comprising repeating said step of reviewing for each annotation and instrumenting said code wherever said meta-annotations have not indicated a problem with their associated annotation.

9. A computer product readable by a machine, tangibly embodying a program of instructions executable by the machine to perform method steps for instrumenting a piece of code, said method steps comprising:
reviewing meta-annotations attached to each annotation definition within said piece of code to determine how to proceed with instrumenting said piece of code.

10. The product of claim 9 and wherein said reviewing comprises considering what the meta-annotations say about when, where, what and how the instrumentation will affect each annotation.

11. The product of claim 9 and also comprising removing said annotation if such is indicated by said meta-annotation.

12. The product of claim 9 and also comprising canceling the instrumentation within a scope of said annotation if such is indicated by said meta-annotation.

13. The product of claim 9 and also comprising moving a portion of said code, as indicated by an attachment level meta-annotation, to another part of said code.

14. The product of claim 9 and also comprising repeating said step of reviewing for each annotation and instrumenting said code wherever said meta-annotations have not indicated a problem with their associated annotation.
